(19) United States
(12) Patent Application Publication
(10) Pub. No.: US 2011/0307349 A1
(43) Pub. Date: Dec. 15, 2011

(54) MOBILE APPLICATION FOR JEWELRY

(75) Inventors: Mihir J. Gandhi, Placentia, CA (US); Paul Hoffman, San Clemente, CA (US); Nihar Nitin Parikh, Mumbai (IN)

(73) Assignee: ASTRAL HOLDINGS, INC., Seattle, WA (US)

(21) Appl. No.: 13/110,798

(22) Filed: May 18, 2011

Related U.S. Application Data
(60) Provisional application No. 61/487,100, filed on May 17, 2011.
(60) Provisional application No. 61/487,091, filed on May 17, 2011.
(60) Provisional application No. 61/345,882, filed on May 18, 2010.

(51) Int. Cl. G06Q 30/00

(52) U.S. Cl. 705/26.5

(57) ABSTRACT

A mobile application runs on a mobile device to allow jewels, jewelry, and their arrangements to be found or virtually made so as to facilitate inspecting, querying, or ordering. Users navigate through various user interface screens to discover jewels and jewelry in inventory of a jewelry merchant. For those jewels and jewelry of interest, they can be collected on a virtual jewel pad. Using the jewel pad, users may arrange jewels and jewelry and order their creation. The mobile application acts as a point of sale for the purchase of jewels, jewelry, or arrangements.

### CROSS-REFERENCES TO RELATED APPLICATIONS

This application claims the benefit of Provisional Application Nos. 61/487,091 and 61/487,100, both filed May 17, 2011, and 61/345,882, filed May 18, 2010, all of which are incorporated herein by reference.

### BACKGROUND

Jewelry, referring to ornaments of precious metal, sometimes set with gems, have been worn since ancient times by humanity for personal adornment as symbols of social or official standing as well as emblems of religious, social, or political affiliation. In its universal sense, the term jewelry encompasses objects made from different kinds of organic and inorganic materials, such as hair, feathers, leather, scales, bones, shells, wood, ceramics, metals, and minerals. However, in modern times, jewelry often refers to mounted precious or semiprecious stones and to objects made of valuable or attractive metals, such as gold, silver, platinum, copper, and brass. Our current historical knowledge of jewelry is derived largely from the preservation of objects in tombs. For cultures that did not bury valuables with the dead, surviving pictorial depictions can provide valuable information about jewelry they used.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating an archetypical system for supporting a mobile application for jewelry;

FIGS. 2-20 are pictorial diagrams illustrating archetypical user interface screens in connection with a mobile application for jewelry; and

FIGS. 21A-21G are process diagrams illustrating an archetypical method for presenting jewelry, making jewelry, and processing jewelry orders.

### DETAILED DESCRIPTION

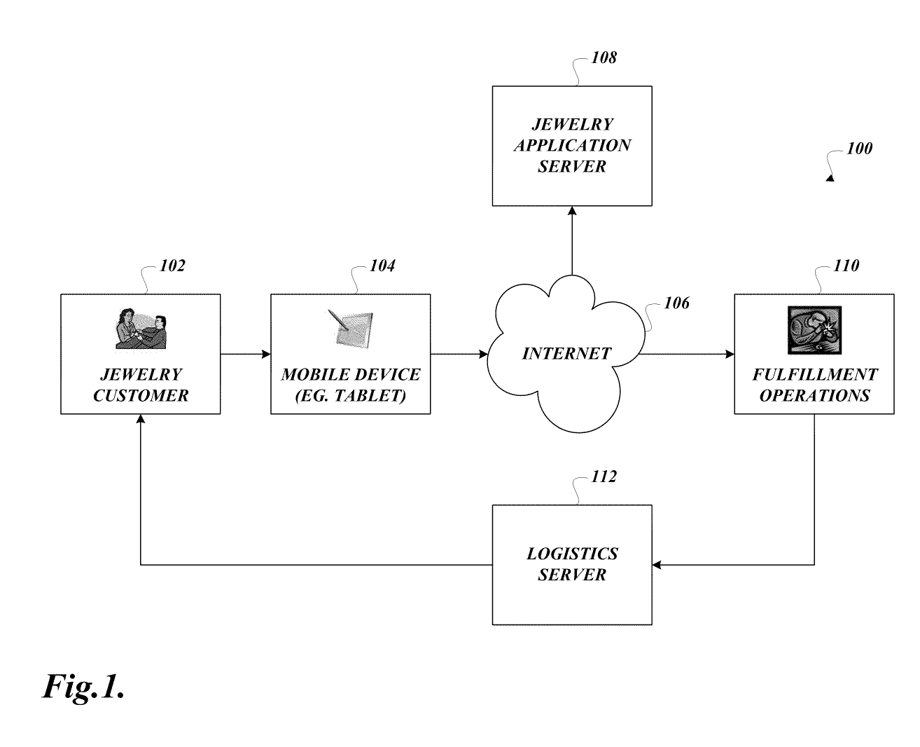

A system 100 for supporting a jewelry mobile application is illustrated at FIG. 1. A jewelry customer 102 accesses a mobile device 104, such as a tablet computer, at either a jewelry store, her home, or other locations. The jewelry customer 102 may include an end-user, a sales professional, or a retailer. Many suitable mobile devices may be suitably used with the system 100 besides a tablet computer, such as a handheld device, handheld computer, personal digital assistant, smartphones, a mobile phone, or a convertible notebook computer. The mobile device 104 is coupled to the Internet 106 to facilitate communication with a jewelry application server 108. The jewelry application server 108 has access to the inventory of jewels and jewelry of one or more jewelry merchants as well as databases and servers that support a mobile application (not shown) executing on the mobile device 104. Orders for jewels or jewelry made on the mobile device 104 are filled by fulfillment operations 110. The fulfillment operations 110 communicate with a logistics server 112 to arrange transportation of ordered jewels or jewelry to the jewelry customer 102 wherever she may be.

Executing on the mobile device 104 is a mobile application for viewing jewelry, virtually arranging jewelry, and ordering jewelry. The mobile application may be downloaded to the mobile device 104 via the Internet 106, or may access a piece of temporary software executing at a remote web site. In all embodiments of the mobile application, the jewelry customer 102 may arrange jewelry and order these jewelry arrangements instead of ordering pre-arranged jewelry. Such an order may be made with a press of a button provided on the mobile application.

Because the jewelry customer 102 may want to inspect multiple jewelry arrangements, a comparison feature is available on the mobile application to allow the jewelry customer 102 to compare one arrangement with another arrangement. Among many other features, the mobile application provides an appraisal functionality as well as order tracking in real time of the shipment of placed orders for jewelry. In one embodiment, order transactions are suitably made to a selected or preferred store merchant of the jewelry customer 102. In such an embodiment, the jewelry customer 102 establishes an account with her preferred store merchant, and such an account is used to place the order for the jewelry. Another option that the customer may select on the mobile application is to indicate whether an ordered arrangement is to be picked up at a preferred store merchant or shipped to her residence or office.

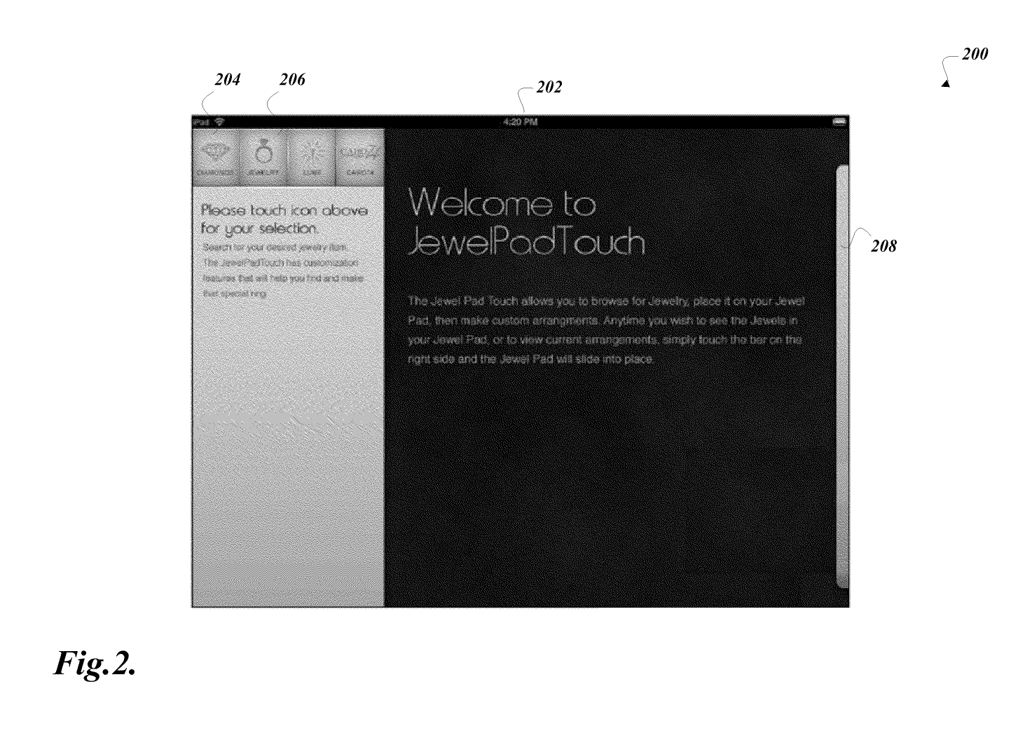

A mobile application 200 deployable on a mobile device 104 allows the jewelry customer 102 to navigate through one or more user interface screens, such as a user interface screen 202 shown at FIG. 2. At the center of the user interface screen 202 is a welcome message indicating to the jewelry customer 102 that she may browse for jewelry, place selected jewelry on a jewel pad 208 (which is a user interface element for collecting jewels and jewelry of interest for the later making of arrangements). At the top left corner of the user interface screen 202 are a number of buttons. A jewel button 204, when selected, allows the jewelry customer 102 to select one or more jewels. Button 206, when selected, allows the jewelry customer 102 to select one or more pieces of jewelry on which one or more selected jewels may be mounted in various arrangements. The jewel pad 208 is a holding area where the jewelry customer 102 can collect jewels and jewelry she would like to inspect later and perhaps use in various arrangements.

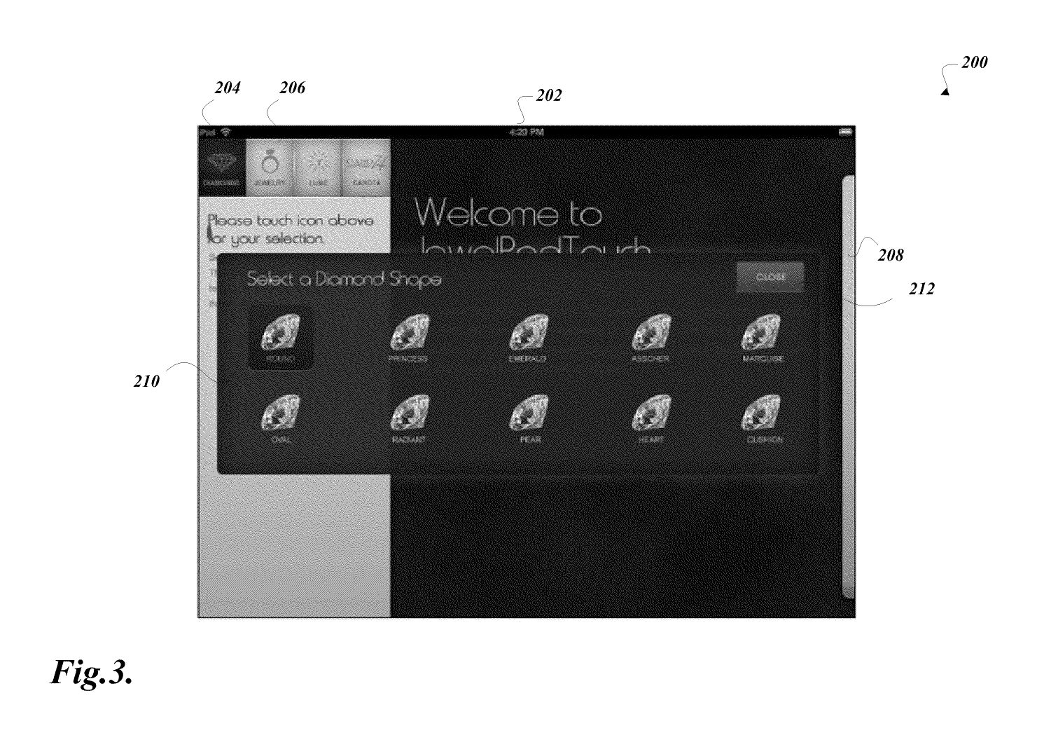

When the jewel button 204 is selected, a pop-up window 210 is presented to the jewelry customer 102 allowing her to select a jewel shape among various jewel shapes, such as round, princess, emerald, Asscher, marquise, oval, radiant, pear, heart, cushion, and so on. See FIG. 3. Once a shape selection is made, a suitable icon reflecting the jewel shape appears in the center of the jewel button 204. A close button 212 allows the jewelry customer 102 to dismiss the pop-up window 210.

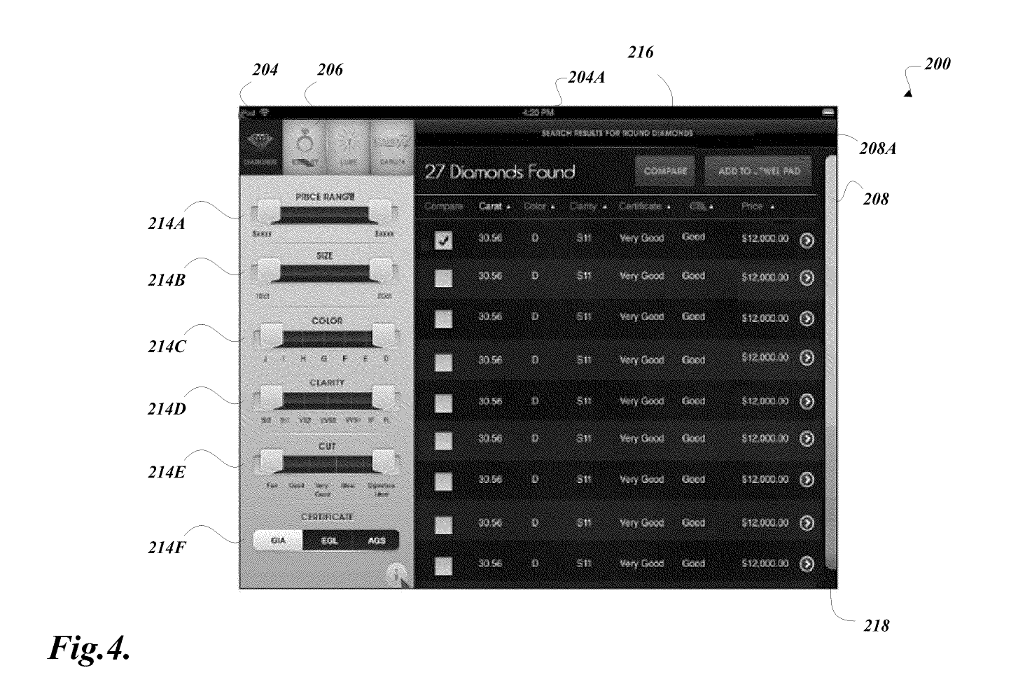

Screen 204a appears after the jewelry customer 102 has selected a particular jewel shape from the pop-up window 210. See FIG. 4. The screen 204a includes a centered title at the top of the screen indicating inventory search results for the selected jewel shape. On the left side of the screen 204a are various filters 214a-214f, which may be operated by the jewelry customer 102 to delimit the range of values or specific values of various filters of interest, for instance price range, size, color, clarity, cut, certification, and so on. The price range filter 214a has a minimum and a maximum value which can be slidably adjusted. Similarly, the size filter 214b allows the size of the jewel to be found between a minimum carat and a maximum carat. The color filter 214c allows the jewelry customer 102 to select the color of the jewel to be found in inventory. The clarity filter 214d allows the clarity of the jewel to be selected within a range. Even the cut of the jewel can be selected between a range by the cut filter 214e. And for those jewelry customers who are interested in the certification of the jewel, the certification filter 214f allows an associated certificate with a selected jewel to be presented.

On the right side of the screen 204a is a matrix 218, which is comprised of rows and columns. Each row denotes a jewel found in inventory that matches the shape of the jewel as well as filter values within a range or specifically indicated by the filters 214a-214f. Each row includes a check box allowing the jewelry customer 102 to select a particular jewel of interest for further processing, such as comparison processing. Each row further includes a detail button, which appears as a circle surrounding a rightward pointing arrow. This button, upon selection, brings the jewelry customer 102 to another screen that provides further information regarding a selected jewel. The columns of the matrix 218 present the values of the various jewels within the filter boundaries selected by the jewelry customer 102. Some of these columns include carat, color, clarity, certificate, cut, and price. Above and leftward of the matrix 218, the screen 204a indicates the number of jewels that were found in inventory that match the shape and the various filter values indicated by the jewelry customer 102. Rightward, a compare button 216 is presented and can be selected to allow checked jewels to be compared. Jewels can be added to the jewel pad 208 via a button 208a which is titled “Add to Jewel Pad.”

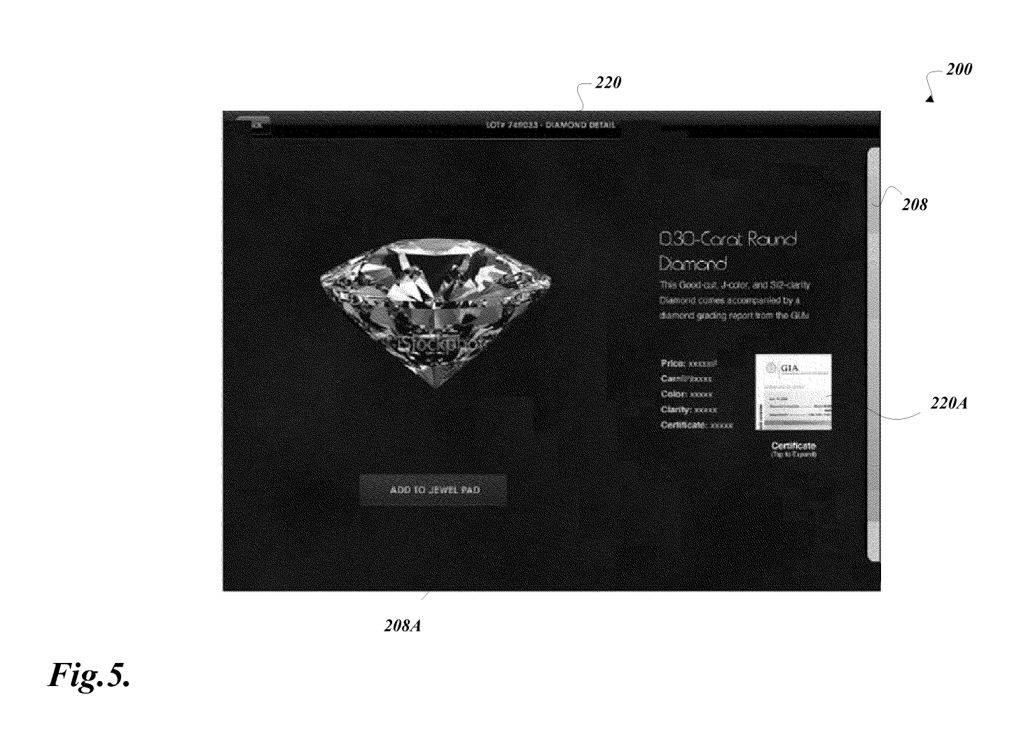

Upon selection of the detail button, which appears as a circle enclosing a rightward pointing arrow, the jewelry customer 102 is brought to screen 220. See FIG. 5. In the upper left corner of the screen 220 a back button appears allowing the jewelry customer 102 to select it to return to screen 204a. (See FIG. 4.) Leftward of the center of the screen 220 is the jewel representation where the checked jewel is presented at a level of magnification. The jewelry customer 102 may touch the jewel and rotate it in various degress by flicking her finger so as to view it three-dimensionally. The right side of the screen 220 includes further information regarding the selected jewel. A representation of a certificate 220a can be tapped by the jewelry customer 102 to inspect the certificate of the selected jewel.

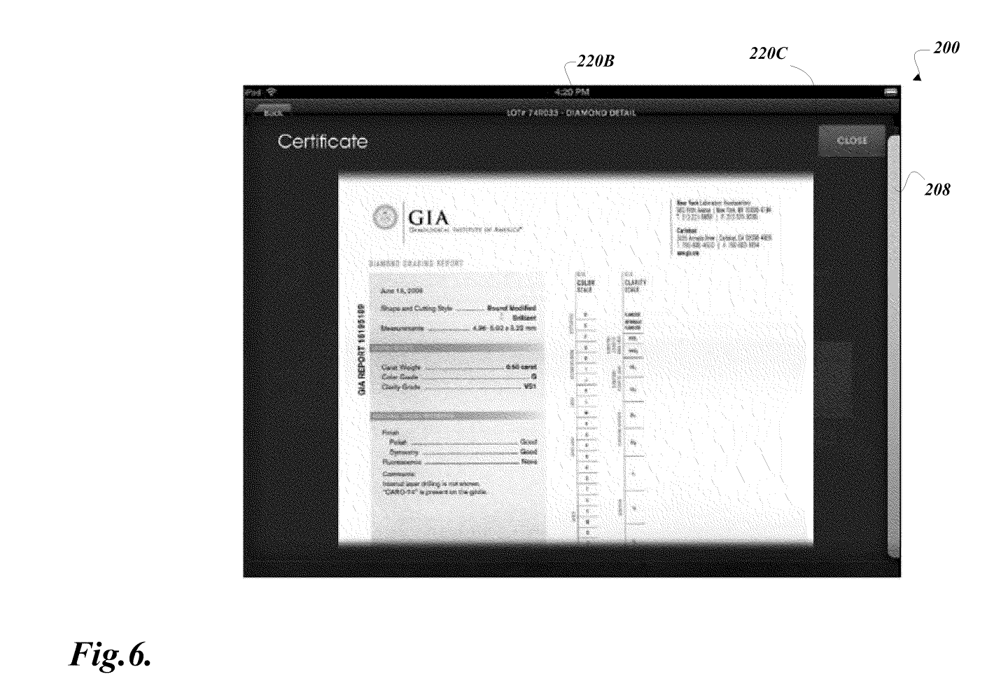

The mobile application 200 then brings the jewelry customer 102 to screen 220b when the jewelry customer 102 selects the certificate representation 220a. See FIG. 6. At the upper left corner of the screen 220b is a back button. Upon selection, the back button brings the jewelry customer 102 back to the screen 220. (See FIG. 5.) At the center of the screen 220b is a magnified certificate or other indicia of certification of the jewel. A close button 220c can be actuated to dismiss the screen 220b and bring the jewelry customer back to screen 220.

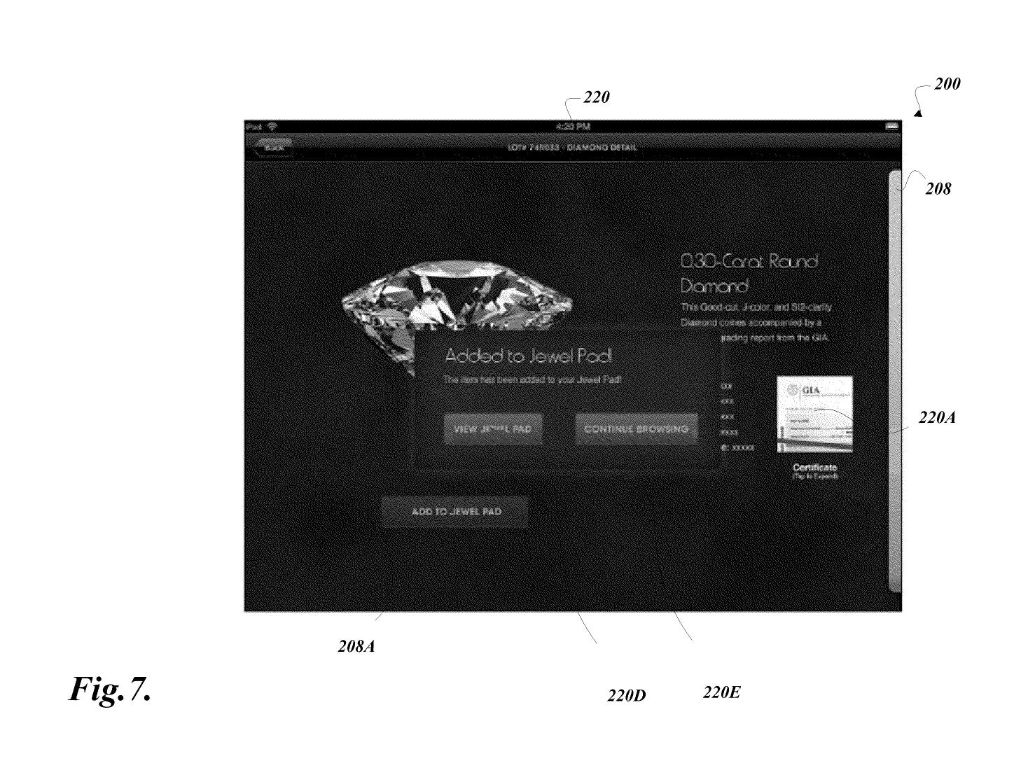

FIG. 7 illustrates a scenario where the button 208a is actuated by the jewelry customer 102. In the upper left corner of the screen 220 a back button appears allowing the jewelry customer 102 to select it to return to screen 204a. (See FIG. 4.) A pop-up window indicates that the checked jewel has been added to the jewel pad 208. Two buttons appear in the pop-up window. One button is titled “View Jewel Pad” 220d, which when selected allows the jewel pad 208 to slide from its hidden position to reveal accumulated jewels and pieces of jewelry. The other button is titled “Continue Browsing” 220e, which when selected brings the jewelry customer back to screen 220 of FIG. 5.

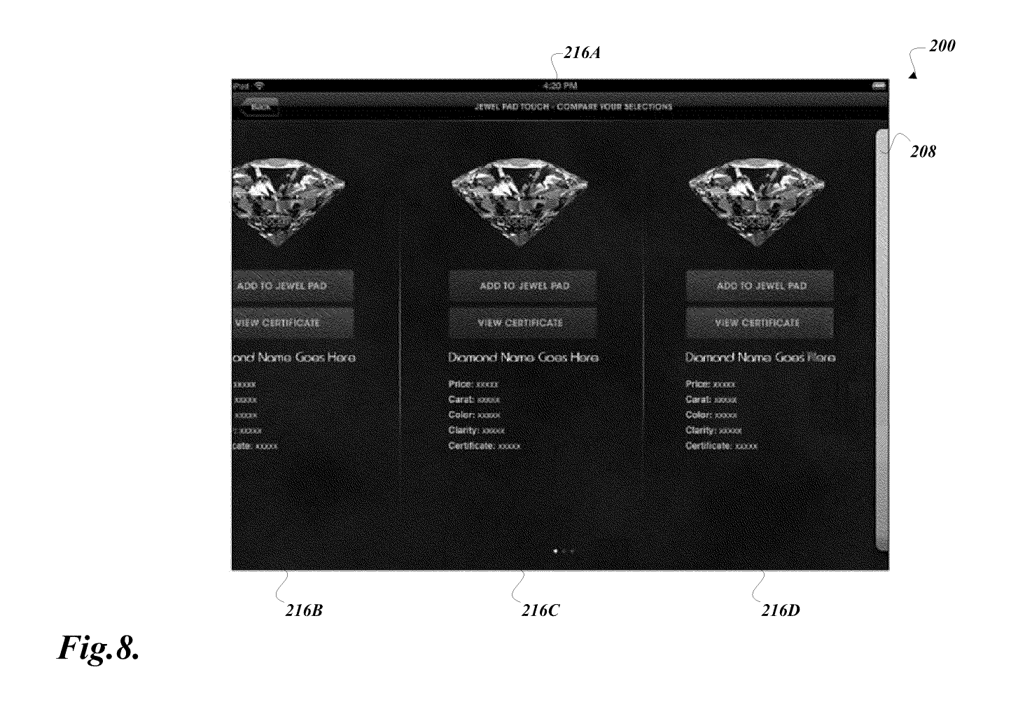

When two or more jewels are checked via their check boxes (see FIG. 4 and screen 204a) and the compare button 216 is selected, the mobile application 200 navigates the jewelry customer 102 to screen 216a. See FIG. 8. In the upper left corner of the screen 216a, a back button appears allowing the jewelry customer 102 to select it to return to screen 204a. (See FIG. 4.) Each checked jewel is presented side by side with another checked jewel. The jewelry customer 102 can swipe left and right to view other checked jewels. Two buttons are provided for each jewel. One is titled “Add to Jewel Pad” 208a. The other button is titled “View Certificate” 220a. Columns 216b-216d illustrate the presentation of compared jewels in which their name, price, carat, color, clarity, certification, and so on are arranged in parallel to ease the comparison process.

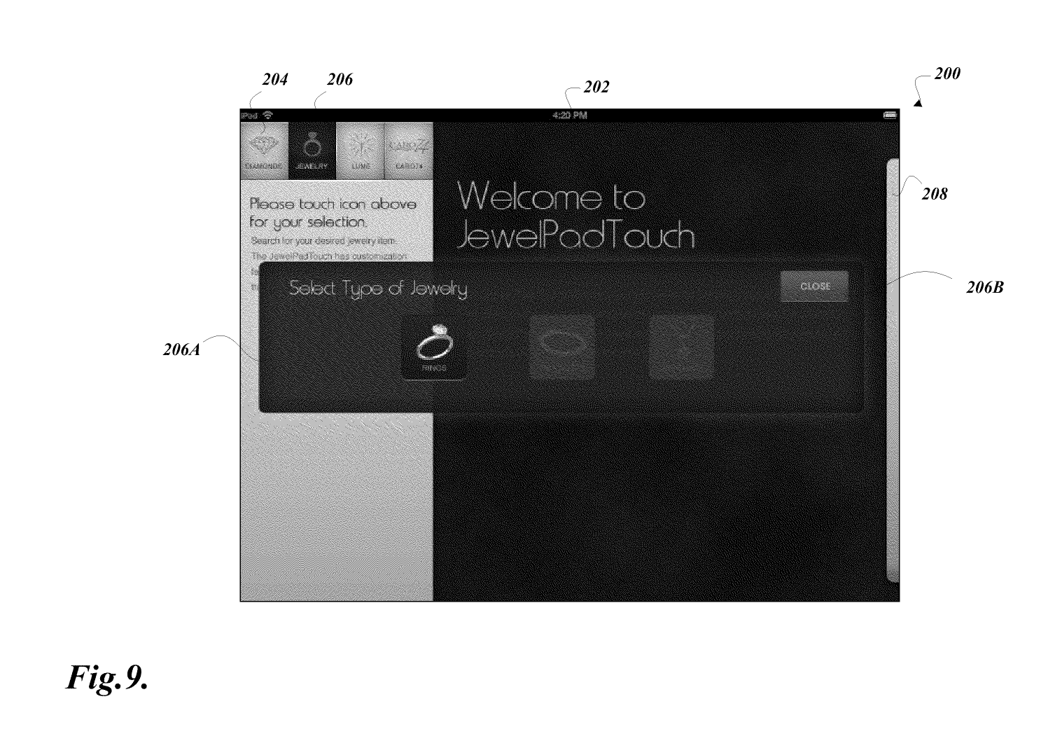

FIG. 9 illustrates screen 202 of the mobile application 200. The jewelry customer 102 has selected jewelry button 206, and in response, the mobile application 200 presents a pop-up window 206a that allows the jewelry customer 102 to select a type of jewelry, such as jewelry for the head in the form of crowns, diadems, tiaras, aigrettes, hairpins, hat ornaments, earrings, nose rings, earplugs, and lip rings; for the neck in the form of collars, necklaces, and pendants; for the breast in the form of pectorals, brooches, clasps, and buttons; for the limbs in the form of rings, bracelets, armlets, and anklets; or for the waist in the form of belts and girdles, with pendants such as chatelaines, scent cases, and rosaries. Many other suitable items of jewelry are possible. A close button 206b is available to allow the jewelry customer 102 to dismiss the pop-up window 206a.

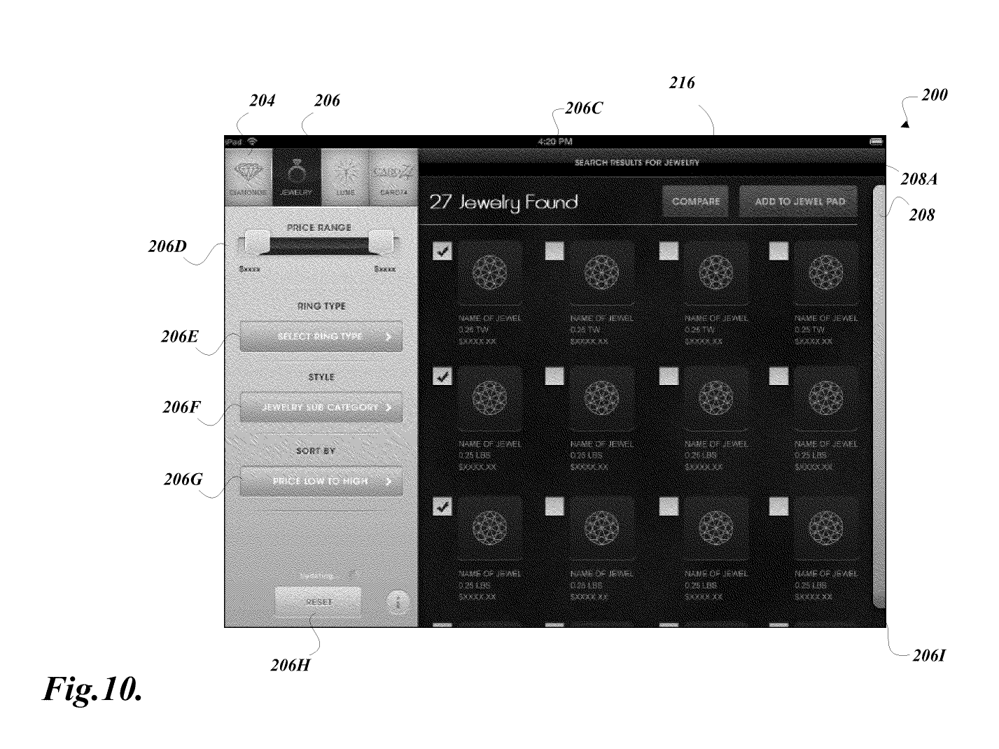

When the selection of the type of jewelry is made, the mobile application 200 navigates the jewelry customer 102 to screen 206c. See FIG. 10. The left side of the screen 206c includes various filters 206d-206g that allow the jewelry customer 102 to gather the jewelry of interest in inventory. A price range filter 206d allows the jewelry customer 102 to delimit the price range that she is interested in. The filter 206e allows the jewelry customer 102 to select the further subtype of the jewelry of interest. For example, there might be various ring types that may be of interest to the jewelry customer 102. The filter 206f allows the jewelry customer 102 to specify the sub style of jewelry that is of interest. The filter 206g allows the matching jewelry to be sorted by a desired order. A button 206h allows the jewelry customer 102 to reset the filter settings. The right side of the screen 206c is a matrix 206i where each cell of the matrix 206i indicates a found piece of jewelry with various details. A check box is associated with each found piece of jewelry to allow the jewelry customer 102 to check for subsequent processing, such as comparison processing. A compare button 216 is available, which when selected invokes the comparison function of the mobile application 200. If a button 208a is selected, the selected pieces of jewelry will be added to the jewel pad 208 for later inspection or arrangement.

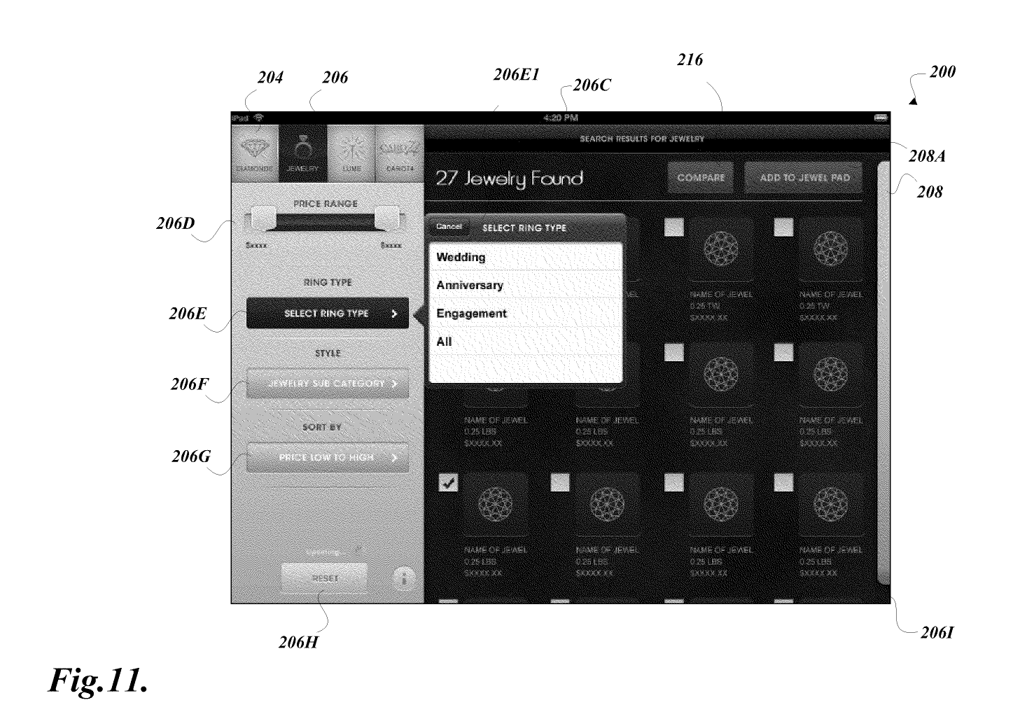

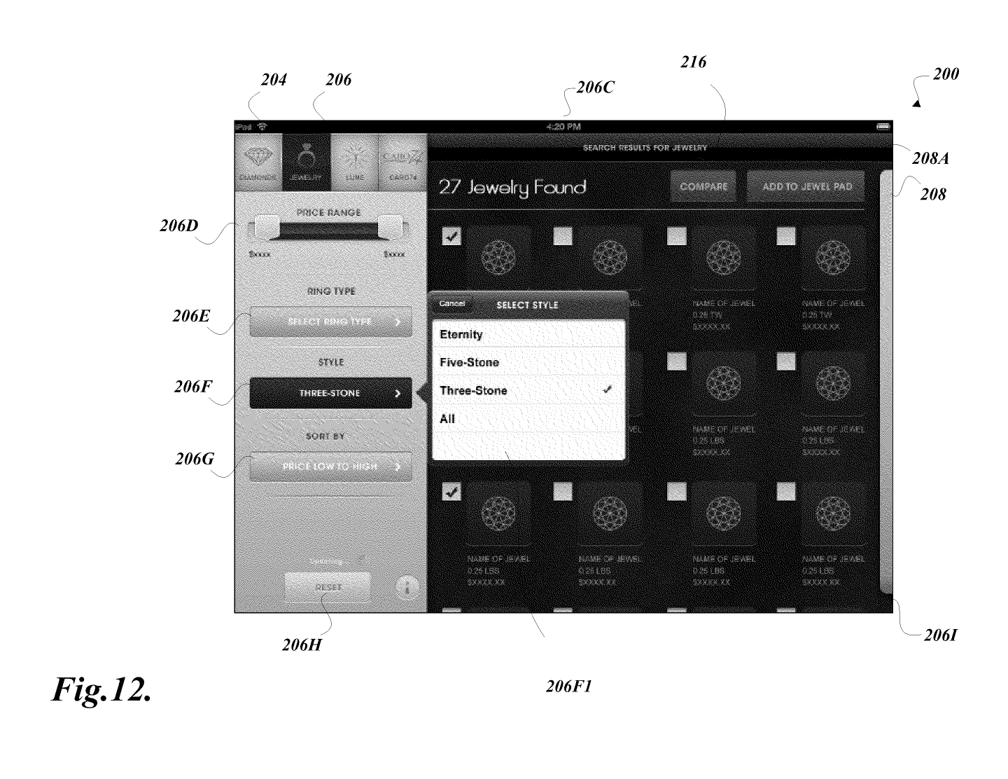

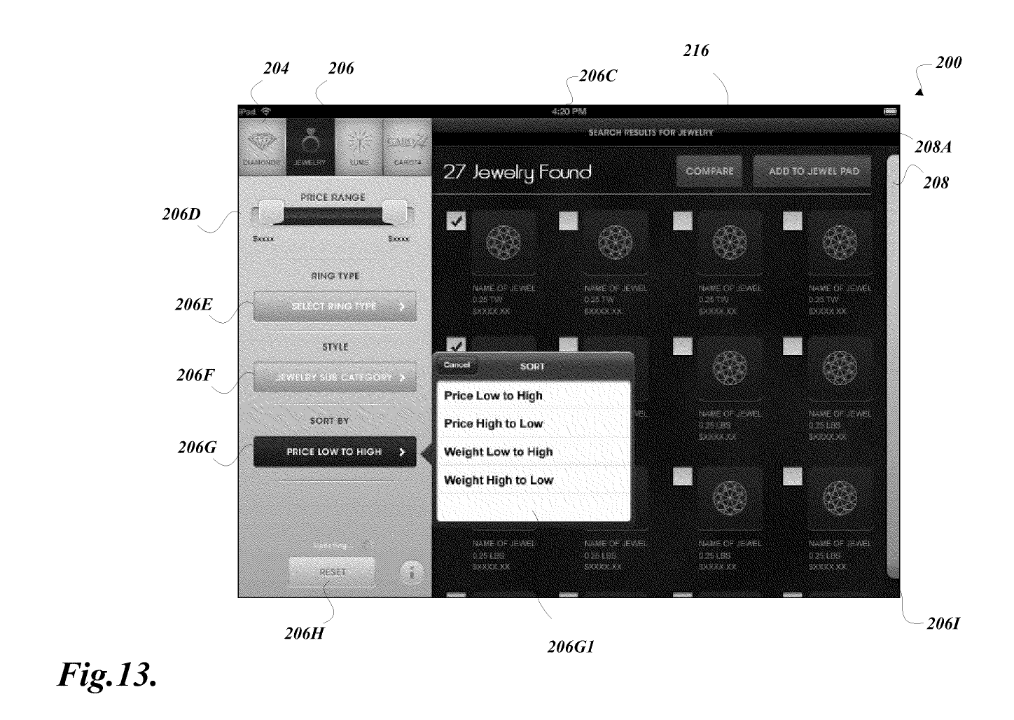

FIG. 11 illustrates selection of the filter 206e. Such a selection causes a pop-up window 206e1 to appear allowing the jewelry customer 102 to select a further type of jewelry. For example, if a piece of jewelry is a ring, the pop-up window 206e1 allows the jewelry customer 102 to further specify various types of rings including wedding, anniversary, engagement, and so on. Actuation of the filter 206f causes a pop-up window 206f1 to appear. See FIG. 12. The pop-up window 206f1 allows the jewelry customer 102 to further specify a desired jewel arrangement. For example, if the piece of jewelry is a ring, various arrangements include eternity, five-stone, three-stone, and so on. FIG. 13 illustrates the actuation of the filter 206g, which causes a pop-up window 206g1 to appear allowing the jewelry customer 102 to specify how the found pieces of jewelry would be ordered in the matrix 206i. For example, options include price low to high, price high to low, weight low to high, weight high to low, and so on.

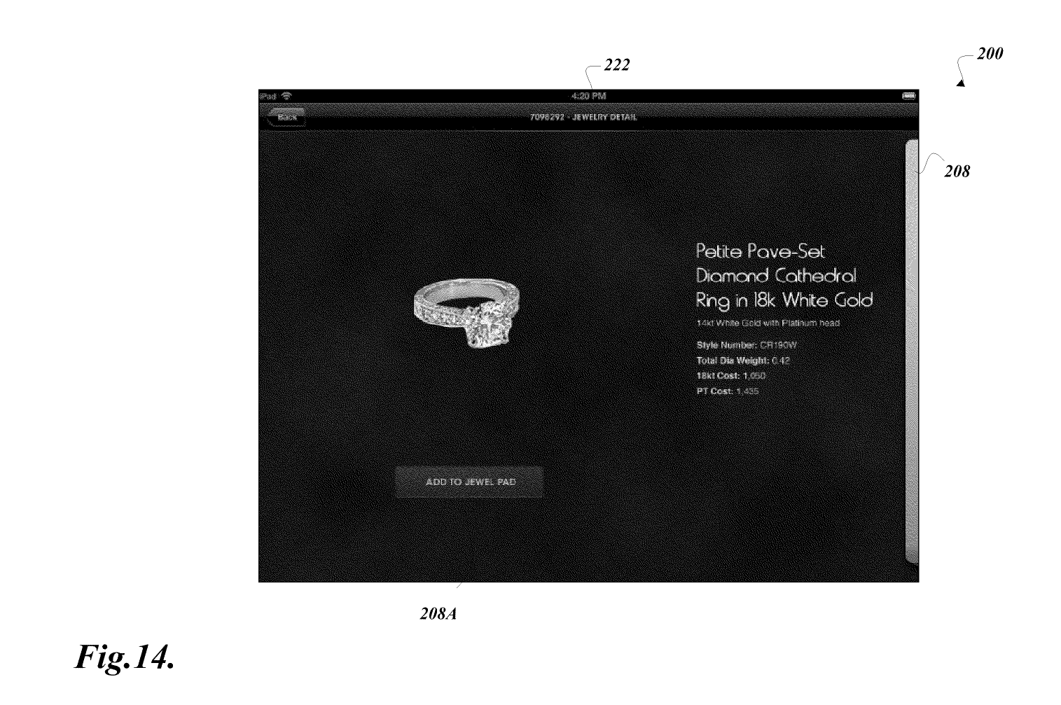

Selecting one of the cells of the matrix 206i, which is associated with a piece of matching jewelry, causes a screen 222 to appear by the mobile application 200. See FIG. 14. In the upper left corner of the screen 222, a back button appears allowing the jewelry customer 102 to select it to return to screen 206c. (See FIG. 10.) The screen 222 prominently displays the piece of jewelry of interest to the jewelry customer 102. The jewelry customer 102 may use her finger to swipe the displayed piece of jewelry to rotate it three-dimensionally. In other words, the jewelry customer 102, by using her finger, can rotate the piece of jewelry in various directions to better inspect the jewelry of interest. To the right of the displayed piece of jewelry is further information pertaining to the piece of jewelry including its commercial description, arrangement elements, style number, weight, cost of jewel, cost of jewelry, and so on.

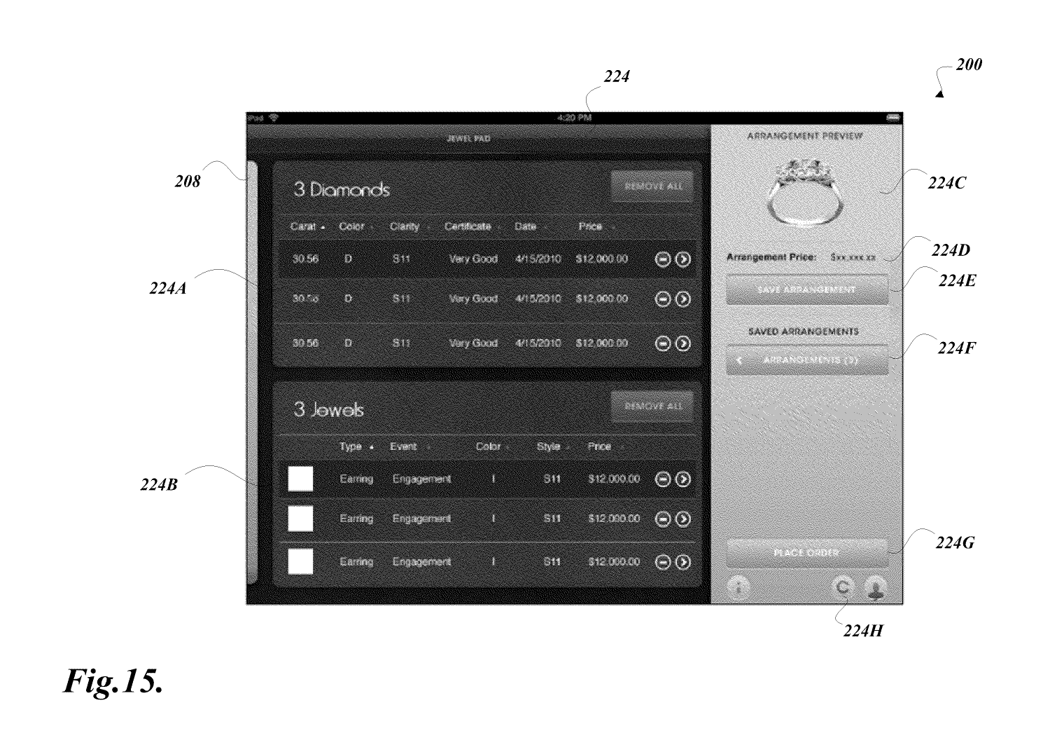

When the jewel pad 208 is actuated, the mobile application 200 causes the jewel pad 208 to slide leftward revealing a screen 224. See FIG. 15. The right side of the screen 224 displays two windows. Window 224a presents added jewels in a matrix where each row denotes an added jewel and each column denotes a specific quality of the jewel, such as carat, color, clarity, certificate, date found, and price. Each row includes two additional buttons at the end of the row. One button is a delete button which appears as a circle enclosing a horizontal bar, which when pressed, deletes the specific jewel from the window 224a. The remaining button is a detail button which appears as a circle encircling a rightward pointing arrow, which when pressed, causes the mobile application 200 to present a detail presentation of the added jewel. The window 224a includes a “Remove All” button, which when pressed, would remove all of the added jewels from the window 224a.

The window 224b presents added pieces of jewelry in a matrix. Each row denotes a specific added piece of jewelry. Each row has a check box, which can be selected by the jewelry customer 102 to indicate that the added jewelry is chosen for arrangement purposes. Each row also includes two buttons appearing at the end of the row. One button is a delete button appearing as a circle enclosing a horizontal line, which when pressed, removes the added piece of jewelry from the matrix. The other button is a detail button appearing as a circle encircling a rightward pointing arrow, which when pressed, causes the mobile application 200 to provide a more detailed presentation of the added piece of jewelry. A remove all button is also presented by the window 224b, which when pressed, dismisses and removes all of the added pieces of jewelry in the window 224b.

By using the windows 224a, 224b, the jewelry customer 102 may select jewels and pieces of jewelry to combine to form one or more arrangements. A preview of such an arrangement is presented on the right hand side of the screen 224 at location 224c. An estimated arrangement price is provided below the preview at location 224d of the screen 224. If the jewelry customer 102 would like to save an arrangement, she may press a button 224e to save the arrangement for later inspection. To access saved arrangements, the jewelry customer 102 may select a button 224f to cause the saved arrangements to appear. If the jewelry customer 102 is satisfied with a specific arrangement as shown at location 224c of the screen 224, she may place an instant order by selecting a button 224g. For consignment, the jewelry customer 102 may opt to select a button 224h which appears at the bottom of the right side of the screen 224.

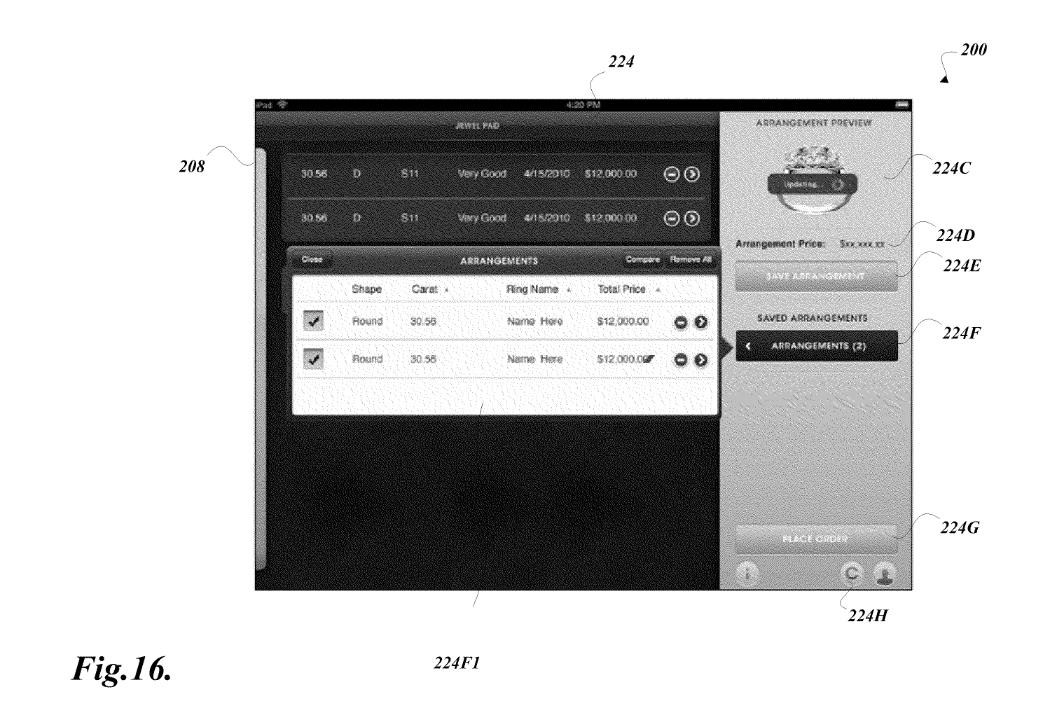

Selecting the button 224f causes the mobile application 200 to present a pop-up window 224f1. See FIG. 16. The pop-up window 224f1 presents a matrix that lists saved arrangements of jewels and jewelry. The upper left corner of the pop-up window 224f1 includes a close button, which when pressed, dismisses the pop-up window 224f1. On the upper right hand corner, the pop-up window 224f1 includes two buttons, a compare button to cause a comparison display of selected arrangements, and another button, titled “Remove All,” to deselect each arrangement and dismiss the pop-up window 224f1.

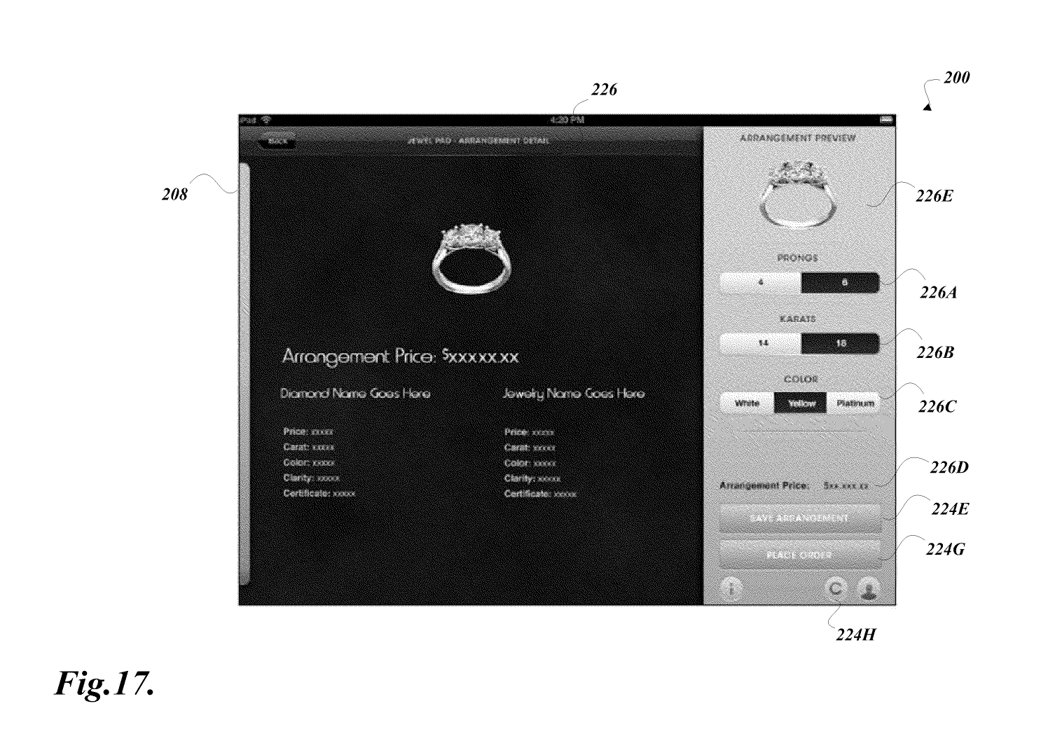

Each row of the matrix denotes a saved arrangement. A check box is associated with each row, which when selected, denotes that the particular arrangement is likely to be used in a comparison process. At the end of each row are two buttons. One button is a delete button which appears as a circle encircling a horizontal dash, which when pressed, removes the particular arrangement and row from the matrix. The other button is a detail button appearing as a circle encircling a rightward pointing arrow, which when pressed, causes the mobile application 200 to present the selected arrangement in greater detail. Such a detail is displayed by a screen 226. See FIG. 17.

The screen 226 presents a saved arrangement that includes a display of the arrangement in magnifying details as a combination of jewels and jewelry, arrangement price, the name of the diamond, the name of the jewelry, price, carat, color, clarity, and certification. The jewelry customer 102 may use her fingers to rotate the arrangement in various degrees to better inspect the arrangement. An arrangement preview is available at location 226e. Below the arrangement preview 226e are further customizations that may be selected by the jewelry customer 102 to further customize the arrangement. For example, location 226a shows options regarding prongs to hold various jewels. Location 226b displays options regarding the carats of the jewels. Location 226c presents options regarding color selection of the jewels. Location 226d indicates an estimated arrangement price. After various selections are made, a button 224e allows the jewelry customer 102 to save the arrangement.

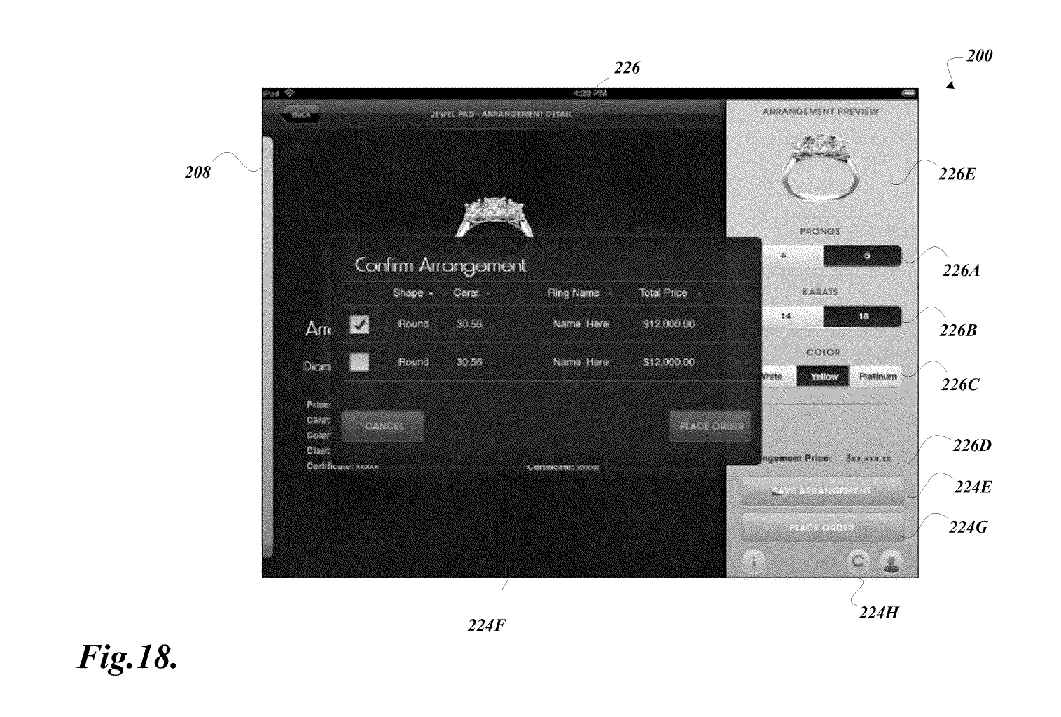

When the button 224g is selected to place an order, the mobile application 200 presents a pop-up window 224f querying the jewelry customer 102 to confirm various arrangements. See FIG. 18. The presentation is made in a matrix where each row denotes an arrangement and each column denotes various details of the arrangement, such as shape, carat, jewelry name, and price. Two buttons are provided, one being the cancel button and the other being the place order button. If the cancel button is selected, the pop-up window 224f is dismissed. If the place order button is selected, the one or more arrangements will be ordered through the system 100.

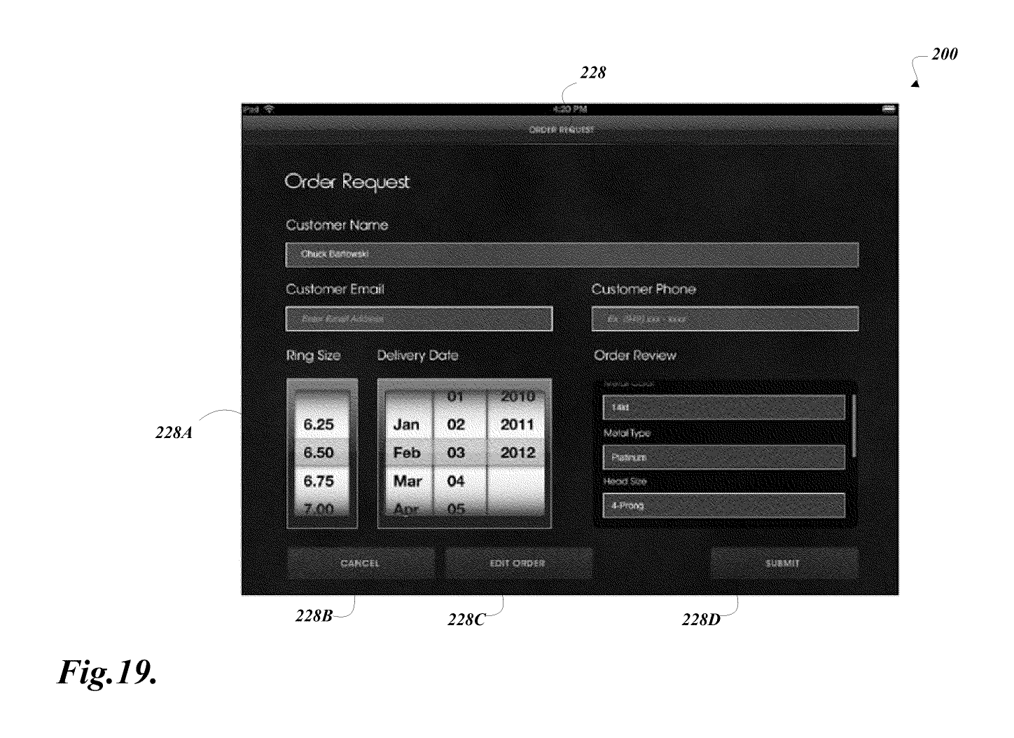

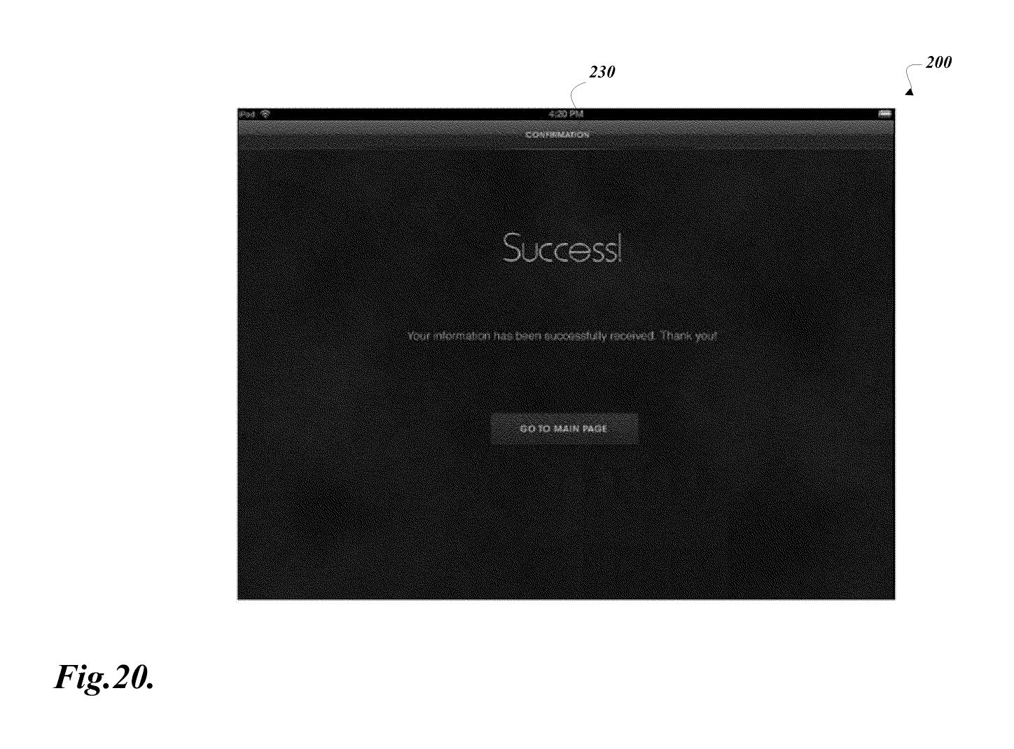

Screen 228 is presented to the jewelry customer 102 by the mobile application 200 when the place order button of the pop-up window 224f is selected. See FIG. 19. The screen 228 presents various inquiries to form an order for the jewelry customer 102. These queries include customer name, customer e-mail, customer phone, ring size 228a, delivery date, and so on. If the jewelry customer 102 decides to abandon the ordering process, a cancel button 228b can be selected to dismiss screen 228. If further details of the arrangement or the order are to be queried, an edit button 228c is pressed to edit the order. Otherwise, the jewelry customer 102 may select the submit button 228d to finalize the purchase. If the order is successfully received by the jewelry application server 108, the mobile application 200 presents screen 230 to indicate to the jewelry customer 102 that the order was successfully received. See FIG. 20.

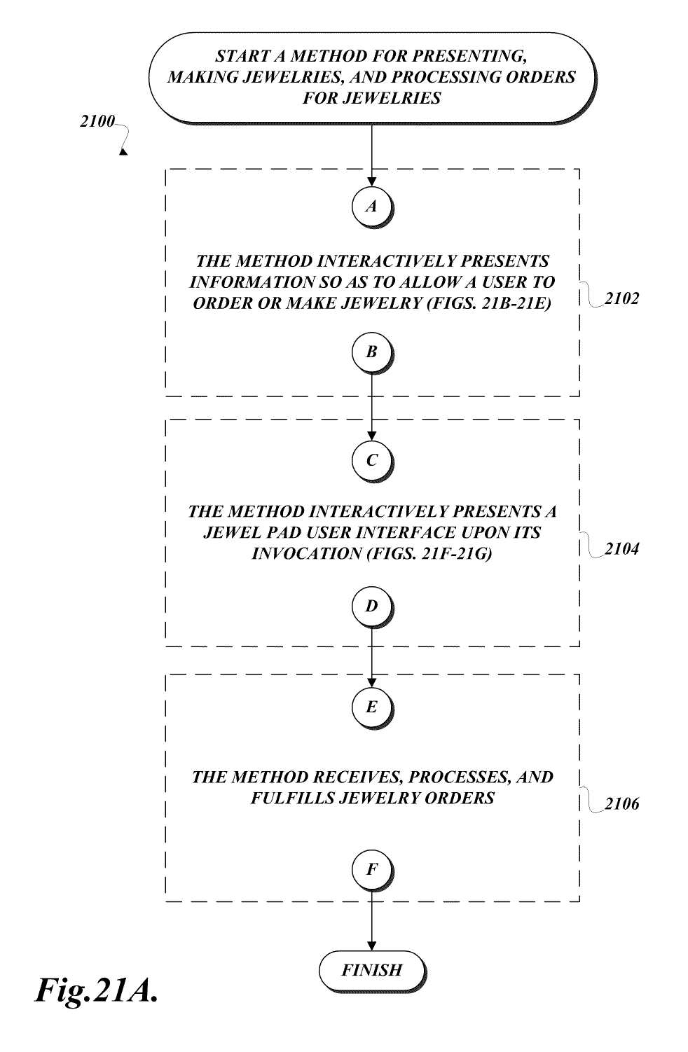

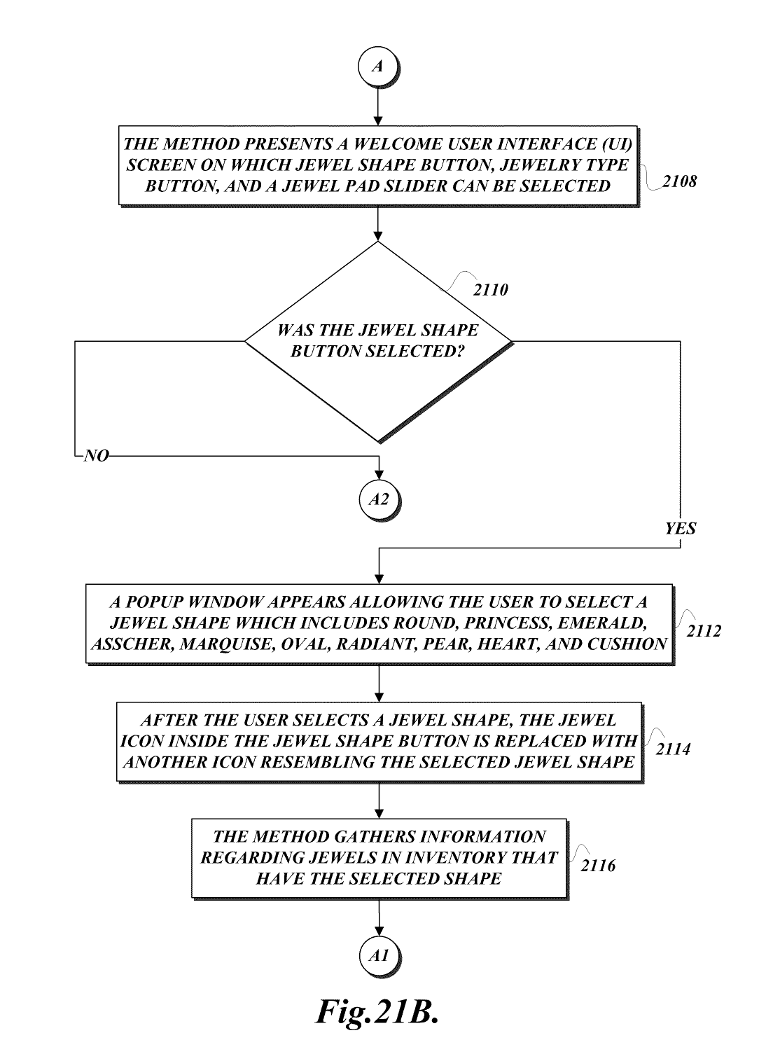

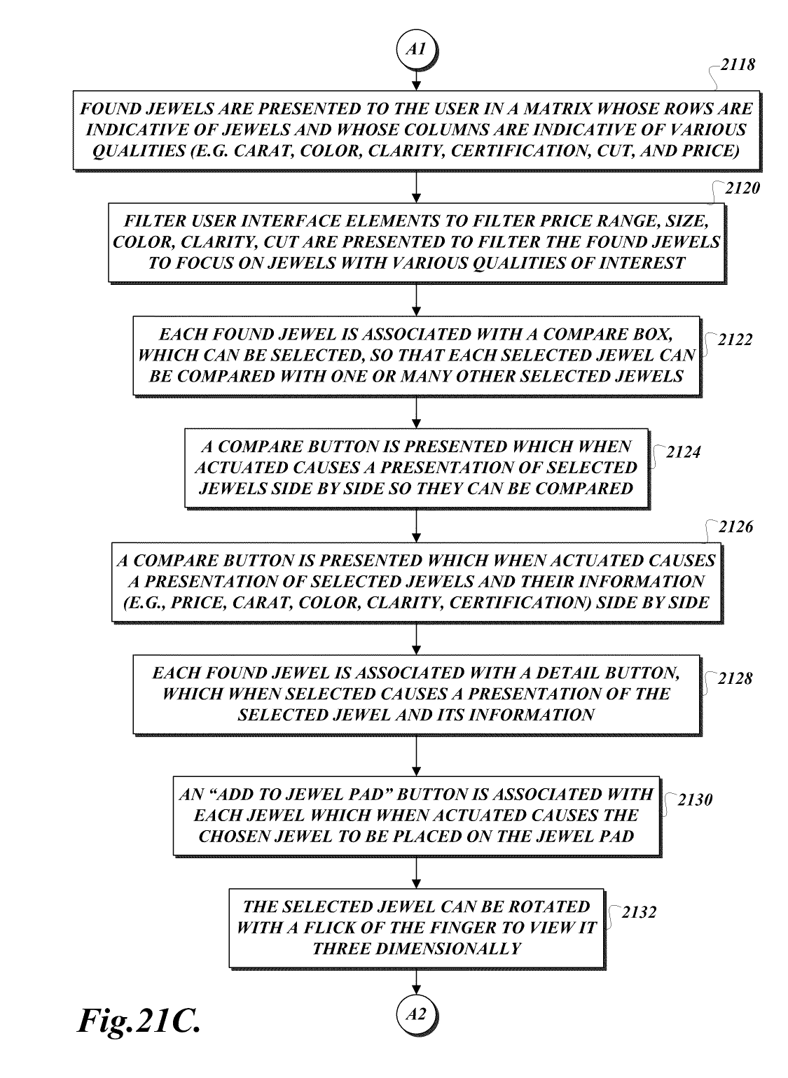

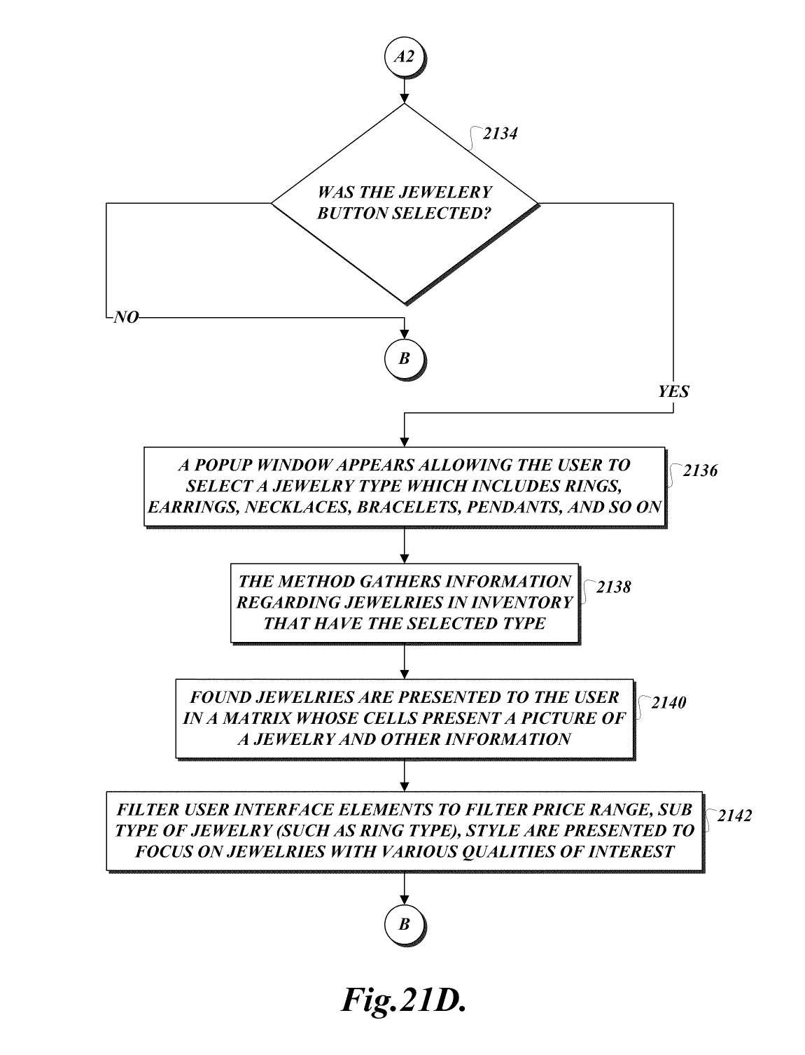

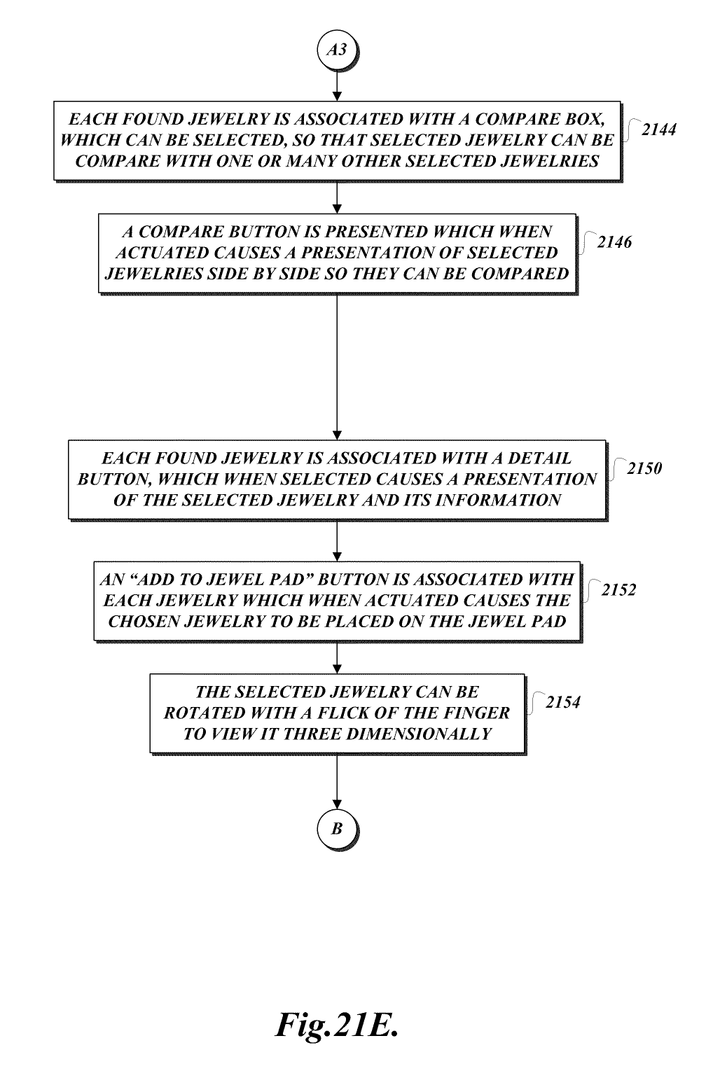

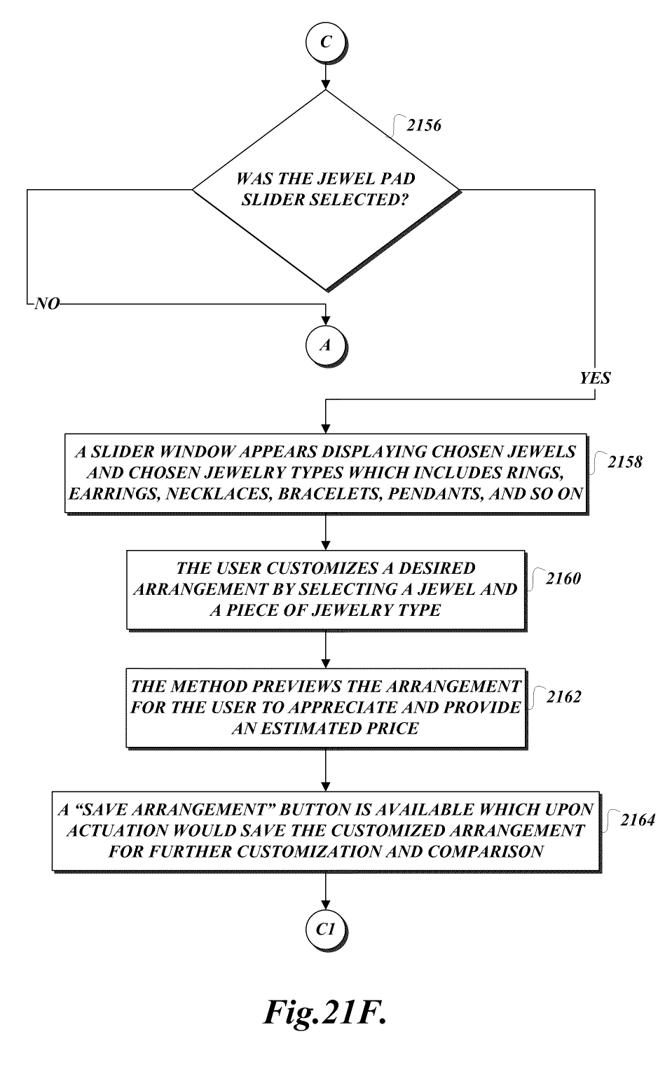

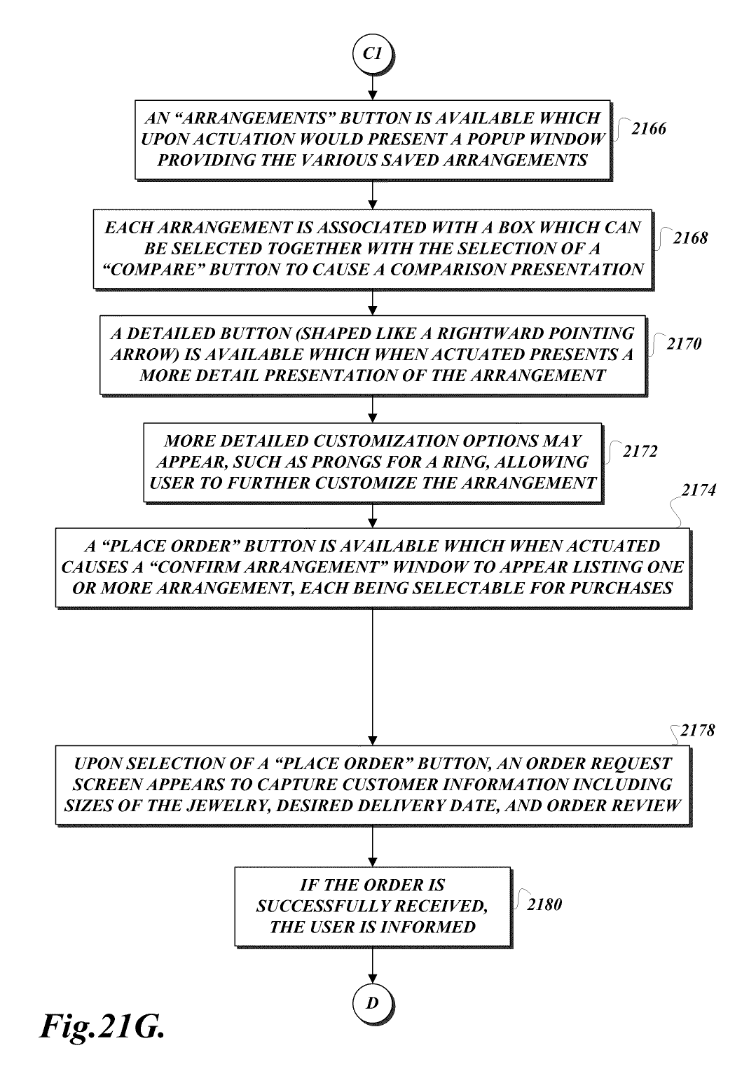

FIGS. 21A-21G illustrate a method 2100 for presenting jewelry, making jewelry, and processing orders for jewelry. From the start block, the method 2100 proceeds to a set of method steps 2102, defined between a continuation terminal (“Terminal A”) and an exit terminal (“Terminal B”). The set of method steps 2102 describes interactively presenting jewelry information so as to allow a user to view, order, or make jewelry arrangements. See FIG. 21B.

From Terminal A (FIG. 21B), the method 2100 proceeds to block 2108 where the method presents a Welcome User interface (UI) screen on which a jewel button, jewelry button, and a jewel pad slider can be selected. Proceeding to decision block 2110, a test is performed to determine whether the jewel button was selected. If the answer is no to the test at decision block 2110, the method 2100 proceeds to another continuation terminal (“Terminal A2”). Otherwise, if the answer is yes to the test at decision block 2110, the method 2100 proceeds to block 2112 where a pop-up window appears allowing the user to select a jewel shape, which includes round, princess, emerald, Asscher, marquis, oval, pear, heart, and cushion. At block 2114, after the user selects a jewel shape, the jewel shape inside the jewel button is replaced with a shape resembling the selected jewel shape. Proceeding to block 2116, the method gathers information regarding jewels and inventory that have the selected shape among other default filter values. The method then continues to another continuation terminal (“Terminal A1”).

From Terminal A1 (FIG. 21C), the method 2100 proceeds to block 2118 where found jewels are presented to the user in a matrix whose rows are indicative of jewels and whose columns are indicative of various qualities (such as carat, color, clarity, certification, cut, and price). Proceeding to block 2120, user interface elements to select price range, size, color, clarity, and cut are presented to filter the found jewels to focus on jewels with various qualities of interest. At block 2122, each found jewel is associated with a compare box, which can be checked, so that each checked jewel can be compared with one or many other checked jewels. A compare button is presented which, when actuated, causes the presentation of checked jewels side by side so they can be compared. See block 2124. At block 2126, a compare button is presented which when actuated causes the presentation of checked jewels and their information (e.g., price, carat, color, clarity, certification) side by side. Proceeding to block 2128, each found jewel is associated with a detail button which, when selected, causes a presentation of the selected jewel and its information. An “Add To Jewel Pad” button is associated with each jewel which, when actuated, causes the chosen jewel to be placed on the jewel pad. See block 2130. At block 2132, the selected jewel can be rotated with a flick of the finger to view it three-dimensionally. The method 2100 then proceeds to another continuation terminal (“Terminal A2”).

From Terminal A2 (FIG. 21D), the method proceeds to decision block 2134 where a test is performed to determine whether the jewelry button was selected. If the answer to the test at decision block 2134 is no, the method continues to exit Terminal B. Otherwise, if the answer to the test at decision block 2134 is yes, the method 2100 proceeds to block 2136 where a pop-up window appears allowing the user to select a jewelry type which includes rings, earrings, necklaces, bracelets, pendants, and so on. At block 2138, the method gathers information regarding jewelry and inventory that have the selected type of jewelry. At block 2140, found jewelry is presented to the user in a matrix whose cells represent pictures of jewelry and other information. At block 2142, filter user interface elements to filter price range, sub-type of jewelry (such as ring type), and style are presented to focus on jewelry with various qualities of interest. The method then continues to exit Terminal B.

From Terminal A3 (FIG. 21E), the method 2100 proceeds to block 2144 where each found jewelry is associated with a compare box, which can be selected, so that the selected jewelry can be compared with one or many other selected pieces of jewelry. At block 2146, a compare button is presented, which when actuated, causes a presentation of selected jewelry side by side so they can be compared. Moving on to block 2150, each found jewelry item is associated with a detail button which, when selected, causes a presentation of the selected jewelry and its information. Proceeding to block 2152, an “Add to Jewel Pad” button is associated with each jewelry item which, when actuated, causes the chosen jewelry to be placed on the jewel pad. At block 2154, the selected jewelry can be rotated with a flick of the finger to view it three-dimensionally. The method then continues to exit Terminal B. From Terminal B (FIG. 21A), the method proceeds to a set of method steps 2104, defined between a continuation terminal (“Terminal C”) and an exit terminal (“Terminal D”). The set of method steps 2104 describes the interactive presentation of a jewel pad user interface upon its invocation. See FIG. 21F.

From Terminal C (FIG. 21F), the method 2100 proceeds to decision block 2156 where a test is performed to determine whether the jewel pad slider was selected. If the answer is no to the test at decision block 2156, the method proceeds to continuation Terminal A and skips back to block 2108 where the above-identified steps are repeated. Otherwise, if the answer to the test at decision block 2156 is yes, the method proceeds to block 2158 where a slider window appears displaying chosen jewels and chosen jewelry types which includes rings, earrings, necklaces, bracelets, pendants, and so on. At block 2160, the user customizes a desired arrangement by selecting a jewel and a piece of jewelry type or multiple jewels and a piece of jewelry type. At block 2162, the method previews the arrangement for the user to appreciate and provides an estimated price. Proceeding to block 2164, a “Save Arrangement’ button is available which upon actuation would save the customized arrangement for further customization and comparison. The method then continues to another continuation terminal (”Terminal C1“).

From Terminal C1, the method proceeds to block 2166 where an arrangement button is available which upon actuation presents a pop-up window providing the various saved arrangements for viewing by the jewelry customer 102. Each arrangement is associated with a check box which can be selected together with a selection of a compare button to cause a comparison presentation. See block 2168. At block 2170, a detail button (shaped like a rightward pointing arrow) is available which when actuated presents a more detailed presentation of the arrangement. At block 2172, more detailed customization options may appear, such as prongs for a ring allowing a user to further customize the arrangement. A place order button is available which, when actuated, causes a Confirm Arrangement window to appear listing one or more arrangements, each being selectable for purchase. See block 2174. At block 2178, upon selection of a place order button, an Order Request screen appears to capture customer information including sizes of the jewelry, desired delivery date, an order review, as well as many other pieces of information. Proceeding next to block 2180, if the order is successfully received, the user is informed. The method then continues to exit Terminal D.

From Terminal D (FIG. 21A), the method 2100 proceeds to a set of method step 2106 where the method receives, processes, and fulfills jewelry orders, which is defined between a continuation terminal (“Terminal E”) and another continuation terminal (“Terminal F”). From Terminal F, the method terminates execution. While illustrative embodiments have been illustrated and described, it will be appreciated that various changes can be made therein without departing from the spirit and scope of the invention.

The embodiments of the invention in which an exclusive property or privilege is claimed are defined as follows:

1. A method comprising:
receiving a jewel specification, finding jewels in inventory that match the jewel specification, and digitally presenting found jewels via a computer display;
receiving a jewelry specification, finding jewelry in inventory that matches the jewelry specification, and digitally presenting found jewelry via the computer display; and
receiving an arrangement specification to form an arrangement from one or more matching jewels and a piece of matching jewelry collected on a jewel pad user interface and digitally presenting the arrangement, which can be rotated by a user by touching the computer display on which the arrangement is being digitally presented.

2. The method of claim 1, wherein receiving the jewel specification further includes receiving a jewel shape specification comprising round, princess, emerald, Asscher, marquise, oval, radiant, pear, heart, and cushion.

3. The method of claim 1, wherein upon receiving the jewel shape specification, a jewel button user interface on the computer display is changed to reflect the jewel shape specification.

4. The method of claim 1, wherein receiving the jewel specification further includes receiving a check box specification for two or more jewels to compare, the method presenting each jewel side by side with another jewel, which can be touched by the user to slide leftward or rightward to reveal other jewels.

5. The method of claim 1, wherein receiving the jewel specification further includes receiving a check box specification for two or more jewels to be added to the jewel pad user interface.

6. The method of claim 1, wherein receiving the jewel specification further includes receiving a filter specification to filter found jewels in accordance with price range, size, color, clarity, cut, and certification.

7. The method of claim 1, wherein receiving the jewel specification further includes receiving a detail specification, which causes a selected jewel to be digitally presented and which can be rotated by the user by touching the computer display on which the jewel is being digitally presented.

8. The method of claim 1, wherein receiving the jewelry specification further includes receiving a jewelry type comprising rings, bracelets, and necklaces.

9. The method of claim 1, wherein receiving the jewelry specification further includes receiving a check box specification for one or more pieces of jewelry to be added to the jewel pad user interface.

10. The method of claim 1, wherein receiving the jewelry specification further includes receiving a filter specification to filter found jewelry in accordance with price range, type, and style.

11. The method of claim 1, wherein receiving the jewel specification further includes receiving a detail specification, which causes a selected piece of jewelry to be digitally presented and which can be rotated by the user by touching the computer display on which the piece of jewelry is being digitally presented.

12. The method of claim 1, wherein receiving the arrangement specification further includes receiving one or more selections of jewels on the jewel pad and a selection of a piece of jewelry on the jewel pad, which causes the one or more selected jewels to be digitally combined with the piece of jewelry to form the arrangement.

13. The method of claim 12, wherein receiving the arrangement specification further includes receiving a detail specification, which causes a selected arrangement to be digitally presented, which can be rotated by the user by touching the computer display on which the arrangement is being digitally presented, the method presenting further arrangement options to the user for further customization of the selected arrangement.

14. The method of claim 13, wherein receiving the arrangement specification further includes receiving a saving specification, which causes a selected arrangement to be saved by the method for later retrieval.

15. The method of claim 14, wherein receiving the arrangement specification further includes receiving a saved arrangement access specification, which causes saved arrangements to be presented in a matrix whose rows denote saved arrangements and whose columns denote shape, carat, name, and price.

16. The method of claim 13, wherein receiving the arrangement specification further includes receiving an order specification, which causes a selected arrangement to be ordered for the user.

17. The method of claim 13, wherein receiving the order specification further includes displaying multiple arrangements if multiple arrangements were saved, displaying a check box with each arrangement so as to allow the user to select one or more arrangements to be ordered.

18. A computer-readable medium, which is tangible, having computer-executable instructions stored thereon to implement a computer-implementable method comprising:
receiving a jewel specification, finding jewels in inventory that match the jewel specification, and digitally presenting found jewels via a computer display;
receiving a jewelry specification, finding jewelry in inventory that matches the jewelry specification, and digitally presenting found jewelry via the computer display; and
receiving an arrangement specification to form an arrangement from one or more matching jewels and a piece of matching jewelry collected on a jewel pad user interface and digitally presenting the arrangement, which can be rotated by a user by touching the computer display on which the arrangement is being digitally presented.

19. A system comprising:
a jewelry application server; and
a mobile device in communication with the jewelry application server to cause a mobile application to receive an arrangement specification to form an arrangement from one or more found jewels and a piece of found jewelry collected on a jewel pad user interface, the mobile application digitally presenting the arrangement, which can be rotated by a user by touching a computer display of the mobile device on which the arrangement is being digitally presented.

20. The system of claim 16, further comprising a logistics server to coordinate delivering ordered jewelry to the user.
